(19) United States
(12) Patent Application Publication
(10) Pub. No.: US 2014/0274237 A1
(43) Pub. Date: Sep. 18, 2014

(54) Double-Walled Plastic Grain Bin With Integrated Support Structure

(71) Applicant: AGCO CORPORATION, Duluth, GA (US)

(72) Inventors: Steven R. Tippery, Newton, KS (US); Bryan S. Claerhout, Hesston, KS (US); Eric M. Reichenberger, Park City, KS (US); Eric Richard Michels, Jackson, MN (US); Eric M. Biggs, Hesston, KS (US); Craig C. May, Park City, KS (US)

(73) Assignee: AGCO CORPORATION, Duluth, GA (US)

(21) Appl. No.: 13/832,925

(22) Filed: Mar. 15, 2013

(51) Int. Cl. A01D 41/12

(52) U.S. Cl. CPC A01D 41/1208
USPC 460/119

(57) ABSTRACT

In one embodiment, a combine harvester comprising a chassis; and a double-walled, plastic grain storage bin coupled to the chassis, the bin comprising an integrated support structure disposed on an interior surface of the bin that contacts crop material processed by the combine harvester.

### TECHNICAL FIELD

The present disclosure is generally related to agriculture technology, and, more particularly, grain storage bins for combine harvesters.

### BACKGROUND

Combine harvesters are provided with a processing system comprising a combine core and a cleaning system. The combine core comprises one or more rotors used to thresh and separate grain. Within the cleaning system, oscillating sieve assemblies in conjunction with air flow remove the chaff from the threshed grain, the latter falling through the chaffer and sieve assembly to an oscillating clean grain pan. The clean grain pan, in turn, directs the clean grain to a discharge auger that elevates the grain to an onboard grain storage bin. A second oscillating pan directs materials other than grain over the edge of the bottom sieve assembly to a different discharge outlet for recirculation back through the threshing, separating and cleaning assemblies of the processing system to extract the previously unthreshed grain.

The grain storage bin is generally a welded, bolted, or riveted steel structure coupled to the chassis of the combine harvester and comprises several parts for support and containment of grain.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates in a front perspective view an example embodiment of a combine harvester.

FIG. 2 is a schematic diagram that illustrates in a front perspective, fragmentary view an example embodiment of a front portion of a combine harvester with an embodiment of a double-walled, plastic grain storage bin.

FIG. 3 is a schematic diagram that illustrates in an overhead, fragmentary view an example embodiment of a double-walled, plastic grain storage bin with various integrated support structures.

FIG. 4 is a schematic diagram that illustrates in top, fore-to-aft, right-hand-side perspective, a fragmentary view of an example embodiment of a double-walled, plastic grain storage bin with various integrated support structures.

FIG. 5 is a schematic diagram that illustrates in top, aft-to-fore, right-hand side perspective, a fragmentary view of an example embodiment of a double-walled, plastic grain storage bin with various integrated support structures.

FIG. 6 is a schematic diagram that illustrates in top, aft-to-fore, left perspective, a fragmentary view of an example embodiment of a double-walled, plastic grain storage bin with various integrated support structures.

FIG. 7A is a schematic diagram that illustrates in top, left-front perspective, fragmentary view, an example embodiment of a double-walled, plastic grain storage bin with vertically-arranged ribs as integrated support structures.

FIG. 7B is a schematic diagram that illustrates in fragmentary, overhead plan view, an example embodiment of the double-walled, plastic grain storage bin of FIG. 7A.

FIG. 7C is a schematic diagram that illustrates in side elevation fragmentary view, an example embodiment of the double-walled, plastic grain storage bin of FIG. 7A.

### DESCRIPTION OF EXAMPLE EMBODIMENTS

### Overview

In one embodiment, a combine harvester comprising a chassis; and a double-walled, plastic grain storage bin coupled to the chassis, the bin comprising an integrated support structure disposed on an interior surface of the bin that contacts crop material processed by the combine harvester.

### Detailed Description

Certain embodiments of a combine harvester having a double-walled, plastic grain storage bin are disclosed that may reduce the quantity of parts and/or weight associated with conventional grain storage bins as well as provide savings when compared to the conventional assembly process of a combine harvester. In one embodiment, a combine harvester is disclosed with a double-walled, plastic grain storage bin, where through the plastic molding process, one or more integrated support structures (e.g., integrated into the bin structure through the plastic molding process) are formed, eliminating or mitigating the need to assemble separately-fabricated (e.g., independent of the plastic molding process) support structures onto the double-walled, plastic grain storage bin while providing further support and/or strength.

Digressing briefly, traditional grain storage bins of combine harvesters comprise a welded, bolted, or riveted steel structure comprising several parts for support and containment of grain. Such large assemblies have many parts, and take considerable time to assemble. In certain embodiments of combine harvesters disclosed herein, the grain storage bin is comprised of a double-walled, plastic material (or blend, such as a blend of polyethylene and nylon), reducing the quantity of sheet-type parts used to contain the crop material (e.g., grain). The double-walled, plastic grain storage bin also comprises, on its interior (and in some embodiments, exterior) surfaces, one or more integrated support structures (e.g., integrated ladder(s), access panel(s), and other integrated support structures such as ribs (e.g., vertical, horizontal, or a combination of both) that are formed in the plastic molding process), which provide further support to the double-walled, plastic grain storage bin while reducing assembly costs involved in the manufacture of combine harvesters.

Having summarized certain features of combine harvesters with double-walled, plastic grain storage bins of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, one focus is on a combine harvester having a transverse-rotor design, though it should be appreciated within the context of the present disclosure that combine harvesters of other designs, such as hybrid, conventional, axial, or dual axial, may be used and hence are contemplated to be within the scope of the present disclosure. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the combine harvester looking forwardly.

Referring now to FIG. 1, shown is an example embodiment of a combine harvester 10 with a double-walled, plastic grain storage bin. It should be understood by one having ordinary skill in the art, in the context of the present disclosure, that the example combine harvester 10 shown in FIG. 1 is merely illustrative, and that other combine configurations may be implemented in some embodiments. The example combine harvester 10 is shown in FIG. 1 without a header, and from front to back, comprises a feeder house 12 and an operator cab 14, followed by a processing system 16 that includes components corresponding to a combine core (e.g., with threshing and separating functionality) and a cleaning system. In operation, the combine harvester 10 includes a harvesting header at the front of the machine that cuts crop materials and delivers the cut crop materials to the front end of the feeder house 12. Such crop materials are moved upwardly and rearwardly within and beyond the feeder house 12 by a conveyor 18 until reaching a thresher rotor 20 of the processing system 16. The thresher rotor 20 comprises a single, transverse rotor, such as that found in a Gleaner® Super Series Combine by AGCO, though some embodiments may have a dual rotor or axial or hybrid configuration. The thresher rotor 20 processes the crop materials in known manner and passes a portion of the crop material (e.g., heavier chaff, corn stalks, etc.) toward the rear of the combine harvester 10 and another portion (e.g., grain and possibly light chaff) to a cleaning system of the processing system 16 to undergo a cleaning process, as described below. In some embodiments, such as in axial flow designs, the conveyor 18 may convey the cut crop material to a beater before reaching a rotor or rotors.

In the processing system 16, the crop materials undergo threshing and separating operations. In other words, the crop materials are threshed and separated by the thresher rotor 20 operating in cooperation with certain elements of a rotor cage 22, for instance, well-known foraminous processing members in the form of threshing concave assemblies and separator grate assemblies, with the grain (and possibly light chaff) escaping through the concave assemblies and the grate assemblies and onto one or more distribution augers 24 located beneath the processing system 16. Bulkier stalk and leaf materials are generally retained by the concave assemblies and the grate assemblies and are disbursed out from the processing system 16 and ultimately out of the rear of the combine harvester 10. The distribution augers 24 uniformly spread the crop material that falls upon it, with the spread crop material conveyed to accelerator rolls 26. The accelerator rolls 26 speed the descent of the crop material toward a cleaning system 28. Also shown is a transverse, air blowing apparatus 30 (e.g., fan, or equivalently, a blower), which discharges pressurized air through one or more ducts, such as ducts 32 (e.g., which in one embodiment, includes an upper duct and lower duct, as explained below, though not limited to two ducts) to the cleaning system 28 to facilitate the cleaning of the heavier crop material directly beneath the accelerator rolls 26 while causing the chaff to be carried out of the rear of the combine harvester 10. The cleaning system 28 includes plural stacked sieves 34 (e.g., also referred to herein as an oscillating sieve assembly), through which the fan 30 provides an additional push or influence (through a lower duct 32, as explained below) of the chaff flow to the rear of the combine harvester 10.

The cleaned grain that drops to the bottom of the cleaning system 28 is delivered by an auger 36 that transports the grain to a well-known elevator mechanism (not shown, but located on the right hand side of the combine harvester 10), which conveys the processed grain to a double-walled, plastic grain storage bin 38 located at the top of the combine harvester 10 (shown in FIG. 1 with flaps, though some embodiments may omit the flaps). Any remaining chaff and partially or unthreshed grain is recirculated through the processing system 16 via a tailings return auger 40. Also shown is a pivoting grain unloading spout 42 (depicted in the stored position) encompassing an auger 44 that cooperates with a cross auger (not shown, but in one embodiment, disposed beneath a portion of the double-walled, plastic grain storage bin 38) to unload the processed grain from the combine harvester 10 to another vehicle. As should be appreciated by one having ordinary skill in the art, the combine harvester 10 also comprises a chassis 46 to which the wheels, drivetrain, steering assemblies, double-walled, plastic grain storage bin 38, cab 14, and processing system 16, among other components, are coupled (and supported). As combine processing and conventional components of a combine harvester are known to those having ordinary skill in the art, further discussion of the same is omitted here for brevity.

FIG. 2 is a schematic diagram of a front portion of the combine harvester 10 and an embodiment of the double-walled, plastic grain storage bin 38 (with an interior space or volume for grain containment referred to herein as a storage volume 48). Note that the flaps (e.g., plastic components formed from the plastic molding process to expand the grain storage capacity of the double-walled, plastic grain storage bin 38) of the storage bin 38 shown in FIG. 1 are omitted here for brevity. In some embodiments, as indicated above, there may be no flaps used in association with the double-walled, plastic grain storage bin 38. The double-walled, plastic grain storage bin 38 (hereinafter, also merely referred to as “bin”) is double-walled, plastic, and polygonal in shape to facilitate the deposit and high capacity storage of grain processed by the processing system 16 (FIG. 1). In one embodiment, the bin 38 is formed through a well-known plastic forming/molding process, such as a rotational molding process. In some embodiments, the bin may be formed according to other mechanisms, such as injection or blow molding processes. The bin 38 may be formed according to a plurality of different geometric configurations and/or sizes, with one goal toward achieving a compatible fit to the now-replaced metal grain storage bin (or in some embodiments, occupying a smaller space). In one embodiment, the space between the dual walls of the bin 38 may comprise a single compartment (or in some embodiments, plural compartments) having a defined fluid storage volume for the storage of fluid to be consumed by the combine harvester 10 (and possibly fluids for other uses, such as personal consumption). The fluid may be used for a given subsystem (e.g., engine/drivetrain, coolant system, catalytic converter, brake system, steering system, etc.) of the combine harvester 10. The fluid may include fuel (e.g., diesel), hydraulic fluid, window wash fluid, diesel exhaust fluid (DEF) (e.g., for selective catalytic reduction (SCR) systems), among other fluids that are compatible with plastic materials. Egress and ingress of the fluid may be enabled by one or more respective output and inlet ports (not shown) disposed on the surfaces of the bin 38. In some embodiments, the space between the dual walls of the bin 38 may not be occupied by fluid(s), but rather remain empty or occupied by insulating or other material. The bin 38 comprises the storage volume 48 located in an interior space of the bin to store processed grain material (e.g., processed in the combine core and cleaning system of the combine harvester 10).

Referring to FIG. 3, shown is an overhead plan view of another embodiment of a double-walled, plastic grain storage bin 38A (hereinafter, also bin) with integrated support structures formed during the plastic molding process. It should be appreciated within the context of the present disclosure that the integrated support structures shown in FIG. 3 are merely example illustrations among other types of integrated support structures, and that in some embodiments, the locations and/or types of integrated support structures may differ from those depicted in FIG. 3. In some embodiments, the bin 38A may include a mixture of integrated support structures and assembled support structures (e.g., the latter not formed during the plastic molding process, or formed as trimmings from the plastic molding process and affixed to the bin 38A using hardware). The bin 38A comprises one or more apertures, such as apertures 50 and 52, which are formed during the plastic molding process. In some embodiments, the apertures may be formed after a molding process. Disposed beneath the aperture 50 is a cross auger 54 running transversely in the combine harvester 10 (FIG. 1). The aperture 50 enables, in one embodiment, an uninterrupted passageway between the interior space of the bin 38A (e.g., the storage volume 48) and the cross auger 54. In some embodiments, a smaller gap or hole (smaller than the aperture 50) may be used. For instance, the cross auger 54 may be housed in a trough (not shown), the trough comprising a metal container with four (4) upright sides that mate with the frame on an underside of the bin 38A, the frame defining a border of the aperture 50. The trough may have an aperture on the left hand side, enabling the cross auger 54 to extend from the interior space of the trough to couple (e.g., via a U-joint) with the auger 44 (FIG. 1) of the unloading spout 42 (FIG. 1). The cross auger 54 conveys the processed crop material or grain (e.g., threshed and separated and cleaned) to the auger 44 of the grain unloading spout 42 for discharge to, for instance, another vehicle. The trough may also serve a function of support for at least a portion of the bin 38A. In some embodiments, the lower surface of the bin 38 may be extended fore-and-aft to encompass the cross auger 54, where an aperture may be disposed on the left hand side of the extended surface for extension of the cross auger 54. With regard to the aperture 52, the processed grain is conveyed to the bin 38A via a well-known elevator mechanism (not shown) that is disposed in aperture 52. In some embodiments, the aperture 52 may be omitted and the elevator mechanism may deposit the grain over one of the sides of the bin 38A. Although described using a conveying apparatus embodied as an auger for grain conveyance, it should be appreciated that in some embodiments, the combine harvester 10 may include additional and/or other conveying apparatuses or mechanisms (e.g., endless belts, slats, etc.). The bin 38A may include other apertures than those described above in association with FIG. 3.

Also shown in FIG. 3 are a plurality of integrated support structures formed in conjunction with (e.g., during) the plastic molding process, including a ladder 56 disposed in an upright front wall 58 (double wall), a ladder 60 disposed in a rear slanted wall 62 (e.g., a double wall, where the bottom stair is accessible only internally to the bin 38A), and a ladder 64 (e.g., where the bottom stair is accessible only internally to the bin 38A) disposed in an upright left sidewall 66 (double wall). In some embodiments, fewer or greater quantities of ladders may be used. In some embodiments, as indicated above, one or more structures that are not-integrated (e.g., assembled to the bin 38A) may be included. In one embodiment, the rear slanted wall 62 has further disposed thereon one or more access panels, such as access panels 68 and 70. These access panels 68, 70 may be hingeably coupled (e.g., an intrinsic hinge, somewhat like the intrinsic hinge of a cardboard box with flaps, or attached via hardware in some embodiments) to the rear slanted wall 62, slideably coupled (e.g., via associated hardware), or removeably coupled. These access panels 68, 70 enable access into the storage volume 48 of the bin 38A. The aforementioned integrated (or in some embodiments, not integrated) support structures provide further support to the double-wall structure of the bin 38A.

Referring now to FIG. 4, shown is another view of the front portion of the bin 38A, further revealing certain features of the integrated support structures among other bin features. In the embodiment depicted in FIG. 4, the bin 38A comprises an additional aperture 72 disposed in the upright front wall 58 (e.g., approximately centrally-located, though not limited to that location or configuration). The ladder 56 is also shown disposed in the upright front wall 58, proximal to the left hand side of the bin 38A. It should be appreciated that other quantities of steps for each depicted ladder, and/or the location of the same, may differ among different embodiments. The ladder 64 is shown disposed on the interior of the upright left sidewall 66, and the ladder 60 (shown with two steps as one example) is depicted on the interior of the rear slanted wall 62 (as well as the access panels 68 and 70).

The bin 38A is also shown with a plurality of ribs, such as rib 74, depicted as horizontally arranged on the interior of the upright left sidewall 66 (with the understanding that other interior wall surfaces may include the ribs in a similar configuration as well). A plurality of ribs 74 may also be arranged on the exterior surfaces of the bin 38A in some embodiments. The ribs 74 are shown arranged horizontally, but in some embodiments, the ribs 74 may be arranged vertically, or comprised of a combination of vertical and horizontal arrangements. The ribs 74 are depicted as extending inward into the storage volume 48, though some embodiments may have the ribs 74 extending rearward (or in both directions in some embodiments) toward the opposing wall of the double wall (e.g., in a full-kiss configuration (side-to-side of the double wall), or in a half-kiss configuration, wherein outward pressure (e.g., from a bin 38A full of grain) causes expansion of the interior walls of the bin 38A that is opposed by the outer walls of the double wall once the rib touches the outer wall).

FIGS. 5-6 show the bin 38A with a plurality of ribs 74 disposed on the interior and some of the exterior surfaces of the bin 38A. In some embodiments, all or only a portion of the internal and/or external surfaces of the bin 38A have the ribs 74 disposed thereon, or in some embodiments, none on any of the surfaces. It should be appreciated that a multitude of different configurations of ribs (and/or other integrated structures) may be formed, and hence are contemplated to be within the scope of the disclosure. In the depicted embodiment of FIGS. 5-6, the upper exterior surfaces of the upright left sidewall 66 and an upright, right sidewall 76, are devoid of ribs 74 on the exterior surface, whereas left and right lower portions 78 (FIG. 6), 80 (FIG. 5) of the bin 38A, respectively, comprise horizontally-arranged ribs 74 disposed thereon. Ribs 74 are also depicted as present on every interior surface (entirely or partially), except the rear slanted wall 62 (though some embodiments may include ribs 74 on the rear slanted wall 62). As indicated above, though depicted with horizontal ribs 74, vertically-arranged, or a combination of vertical and horizontal ribs 74 may be used on one or more surfaces, and hence are contemplated to be within the scope of the disclosure.

Attention is now directed to another embodiment of a double-walled, plastic grain storage bin 38B, shown in FIGS. 7A-7C, which shows the bin 38B in various views, where the only integrated support structures are vertical ribs 82 on each of the walls of the bin 38B. For instance, in FIG. 7A, the ribs 82 are shown along a transverse area of a defined height along an interior surface of a an upright rear wall 84 and the in a similar configuration on the interior surface of the upright, right sidewall 76A (with the understanding that the other interior walls are similarly configured but obscured from view in FIG. 7A). In FIG. 7B, the overhead plan view reveals the bin 38B to have the ribs 82 along the interior surfaces of the upright left and right sidewalls 66A and 76A, respectively, and along the interior surfaces of the upright front wall 58A and the upright rear wall 84. It is noted that no ribs 82 are depicted on the exterior surface (though not limited as such). It should be appreciated that fewer or greater quantities of ribs 82 may be used in some embodiments. Referring to the cut-away (A-A) of FIG. 7C, the ribs 82 of the bin 38B are shown disposed on the interior surface of an upright right sidewall 76A.

As is clear from the example embodiments described above, certain embodiments of a combine harvester 10 (FIG. 1) with a double-walled plastic grain storage bin 38 (FIG. 1) having integrated support structures may enable a reduction in assembly costs and/or quantity of parts associated with conventional metal grain bins.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A combine harvester, comprising:
a chassis;
a processing system coupled to the chassis, the processing system comprising threshing, separating and cleaning components; and
a double-walled, plastic grain storage bin coupled to the chassis, the bin comprising a plurality of integrated support structures disposed on interior surfaces of the bin that contact crop material processed by the processing system.

2. The combine harvester of claim 1, wherein the plurality of integrated support structures are disposed on plural sides of the bin.

3. The combine harvester of claim 1, wherein one of the plurality of integrated support structures comprises a ladder.

4. The combine harvester of claim 3, wherein a bottom of the ladder is only accessible from inside the bin.

5. The combine harvester of claim 1, wherein one of the plurality of integrated support structures comprises an access panel.

6. The combine harvester of claim 5, further comprising an additional access panel.

7. The combine harvester of claim 1, wherein one of the plurality of integrated support structures comprises a plurality of ribs, the ribs extending from at least one of the double walls toward a center of the bin.

8. The combine harvester of claim 7, wherein the ribs are arranged vertically.

9. The combine harvester of claim 1, wherein the bin comprises an additional plurality of integrated support structures disposed on exterior surfaces of the bin.

10. The combine harvester of claim 9, wherein the plurality of integrated support structures disposed on the exterior surfaces of the bin are disposed on plural sides of the bin.

11. The combine harvester of claim 1, further comprising a conveying apparatus and plural apertures, wherein a first of the plural apertures is disposed on the bottom of the bin and comprises an uninterrupted passageway between an interior volume of the bin and the conveying apparatus.

12. The combine harvester of claim 11, wherein a second of the plural apertures enables a flow of the processed crop material to the bin.

13. The combine harvester of claim 1, wherein the bin and the integrated support structures are formed in a rotational molding process.

14. A combine harvester, comprising:
a chassis; and
a double-walled, plastic grain storage bin coupled to the chassis, the bin comprising an integrated support structure disposed on an interior surface of the bin that contacts crop material processed by the combine harvester.

15. The combine harvester of claim 14, further comprising a processing system coupled to the chassis, the processing system comprising a threshing and separating rotor and a cleaning system that processes crop material.

16. The combine harvester of claim 14, further comprising one or more additional integrated support structures that are disposed on one or more interior surfaces of the bin, one or more exterior surfaces of the bin, or a combination of both.

17. The combine harvester of claim 16, wherein the integrated support structure and the one or more additional integrated support structures comprises one or any combination of a ladder, a rib, or a hingeable access panel.

18. The combine harvester of claim 17, wherein the rib is arranged vertically.

19. The combine harvester of claim 17, wherein the bin and the integrated support structure and the one or more additional integrated support structures are formed in a rotational molding process.

20. A combine harvester, comprising:
a chassis; and
a rotationally-molded, double-walled, plastic grain storage bin coupled to the chassis, the bin comprising a first storage volume that receives and stores crop material processed by the combine harvester and a plurality of integrated support structures disposed on interior surfaces of the bin that contact the processed crop material.
